(19) United States
(12) Patent Application Publication
(10) Pub. No.: US 2022/0330688 A1
(43) Pub. Date: Oct. 20, 2022

(54) STYLE SEALERS APPLICATOR

(71) Applicant: Young $ Company Global L.L.C., Burnsville, MN (US)

(72) Inventor: LaRon Ray Young, Minneapolis, MN (US)

(73) Assignee: Young $ Company Global L.L.C., Burnsville, MN (US)

(21) Appl. No.: 17/719,936

(22) Filed: Apr. 13, 2022

Related U.S. Application Data
(60) Provisional application No. 63/201,126, filed on Apr. 14, 2021.

(51) Int. Cl. A46B 11/00; A46B 9/02; B65D 83/28

(52) U.S. Cl. CPC A46B 11/002; A46B 11/0062; A46B 9/023; B65D 83/285; A46B 2200/1046

(57) ABSTRACT

Devices, methods, and systems for a Style Sealer Applicator are described herein. One system includes a refillable reservoir integrated into a hair styling tool to dispense hair care products while styling. In some examples, a reservoir is embedded into the handle of a hair styling device and a spring loaded button pressurizes the reservoir to dispense the hair care product through nozzle applicators patterned with other bristles while styling.

### BACKGROUND

Hair grooming devices can be used to style, straighten, or untangle hair while a user applies hair care product to the hair and scalp. The product can be an oil, gel, or lotion that is applied to the scalp or hair to improve scalp and hair health. In some previous examples, hair grooming devices have applicator devices of hair care product that fail to distribute the product evenly throughout the hair while adequately styling the hair at the same time.

### BRIEF DESCRIPTION OF THE DRAWINGS

FIG. 1 is an example of a. Style Sealers Applicator 100 in the form of a brush according to one or more embodiments of the present disclosure.

FIG. 2 is an example of a Style Sealers Applicator 200 in the form of a comb according to one or more embodiments of the present disclosure.

FIG. 3 is an example of a Style Sealers Applicator 300 in the form of a wave brush according to one or more embodiments of the present disclosure.

FIG. 4 is an example of a Style Sealers Applicator 400 in the form of a hair pick according to one or more embodiments of the present disclosure.

FIG. 5 is an example of a Style Sealers Applicator 500 in the form of an edge control brush according to one or more embodiments of the present disclosure.

### DETAILED DESCRIPTION

Haircare devices, methods, and systems are described herein. The Style Sealers Applicator can be a series of devices that applies hair care products at the same time as styling of the hair for ease of use and a more uniform application of the hair care product. For example, one or more embodiments can include a hair care applicator device with a push button activation for distributing product onto the hair and scalp through the nozzle applicators in the device. In some examples the nozzle applicators are intertwined with bristles to create a pattern to evenly distribute product onto the hair or scalp when the product is pushed through the device from the activation of the reservoir. The Style Sealers Applicator has an input valve that allows the reservoir to be refilled with hair care product. This input valve could have some form of sealing mechanism that allows the reservoir to be filled but otherwise seals the reservoir to allow it to be activated. Previous systems could utilize an applicator system to distribute hair care product through nozzles in a brush. These previous systems could be in the form of a brush or a pick that may have an external pump or actuation device to distribute hair care products.

In these previous systems the actuation system requires two hands to operate or requires the user to squeeze the handle to actuate the device and distribute the hair care product. This could cause the user to struggle to style the hair correctly with the tool and evenly distribute the hair care product by maintaining a consistent flow, in some instances this can lead to an over or under application of the product in the hair or scalp. In some instances this can contribute to frayed or loose hair that doesn't achieve the desired effects that the user intends when styling the hair using a hair care product.

The present disclosure describes a substance applicator device that includes a handle with a hollow core, a reservoir positioned within the hollow core of the handle, an input port coupled to the reservoir to fill a hair care product into the reservoir, an actuation device that is coupled to the handle and coupled to the reservoir to pressurize the reservoir, a plurality of nozzle applicators as an outlet for dispensing the hair care product from the device, and a plurality of bristles. In some examples, the actuation device can force a hair care product within the reservoir through a manifold to the plurality of nozzle applicators. In this way, an equal or relatively equal quantity of hair care product can be dispensed from the plurality of nozzle applicators during application. Previous examples that do not utilize a manifold between the actuation device or pressurization device can apply different quantities to different nozzle applicators. The present disclosure can utilize a reservoir that is coupled to the plurality of nozzle applicators by a piece of tubing coupled to a distributor manifold capable of transporting the hair care product from the reservoir to each aperture of the plurality of nozzle applicators.

In some examples, the actuation device is a spring loaded push button that can be depressed to dispense the hair care product through the plurality of nozzle applicators. In this way, the spring loaded push button can be depressed to force the hair care product from the reservoir through the manifold to the plurality of nozzle applicators utilizing a pressure provided by the actuation device. In some examples, the plurality of bristles and the plurality of nozzle applicators are inter-spaced on a brush head that is coupled to the handle. In some examples, the plurality of nozzle applicators are offset from the length of the plurality of bristles such that the plurality of bristles are longer than the plurality of nozzle applicators. In this way, a distance exists between a tip of the plurality of bristles and a tip of the plurality of nozzle applicators to allow the hair care product to be moved by the plurality of bristles and/or be positioned within a cavity formed between the offset distance.

In other embodiments, the present disclosure includes a substance applicator device that includes a handle with a hollow core, a reservoir positioned within the hollowed out core of the handle, an input port coupled to a surface of the handle and coupled to the reservoir to insert a hair care product into the reservoir, an actuation device that is coupled to the handle and coupled to the reservoir to pressurize the reservoir, a plurality of nozzle applicators as an outlet for dispensing the hair care product from the device, and a plurality of bristles oriented in a configuration with the plurality of nozzle applicators to create a pattern. In these examples, the actuation device is a spring loaded push button that can be depressed to increase a pressure within the reservoir to dispense the hair care product from the plurality of nozzle applicators.

In some examples, the plurality of nozzle applicators are offset from the length of the plurality of bristles such that the plurality of bristles would be longer than the plurality of nozzle applicators. As described herein, the offset can be provided by a difference in length between the plurality of bristles and the nozzle applicators. In these examples, the plurality of bristles and the plurality of nozzle applicators are inter-spaced on a brush head that is coupled to the handle. In these examples, the pattern of bristles and nozzle applicators is oriented in an oval with a long axis running parallel to the length of the handle. Furthermore, the plurality of bristles can be semi-rigid and a same length as the handle.

In some examples, the pattern of bristles and nozzle applicators are oriented with a single row running perpendicular to the length of the handle. In this way, a center of the handle can align with the plurality of bristles and nozzle applicators. In some examples, the plurality of nozzle applicators are positioned in a center of the single row and on the two ends with the plurality of bristles inter spaced in between. That is, the nozzle applicators can include a plurality of bristles on a first side and a second side. In these examples, a first line of bristles can extend along the first side of the nozzle applicators and a second line of bristles can extend along the second side of the nozzle applicators.

In other embodiments, the present disclosure includes a substance applicator device that includes a handle with a hollow core, a reservoir positioned within the hollowed out core of the handle, an input port coupled to a surface of the handle and coupled to the reservoir to insert a hair care product into the reservoir, a push button actuation device that can be depressed to dispense hair care product from the reservoir, a plurality of nozzle applicators as an outlet for dispensing the hair care product from the device, and a plurality of bristles oriented in a configuration with the plurality of nozzle applicators to dispense the hair care product from the device. In these examples, the plurality of bristles are made out of a material that has a relatively lighter stiffness to accommodate styling of hair. In some examples, the stiffness to accommodate styling of hair includes a stiffness that allows the bristle to bend and then return to it's original orientation without deformation.

In some examples, the plurality of nozzle applicators are spaced evenly and linearly in a single row running perpendicular to the length of the handle. For example, a center of the handle can be perpendicular to the line or single row of nozzle applicators. In some examples, the pattern of bristles and nozzle applicators are oriented in an oval with a long axis running parallel to the length of the handle. As used herein, a long axis of the oval can be an elongated portion of the oval. In other examples, the plurality of nozzle applicators are spaced in a diamond configuration with the plurality of bristles inter spaced in between the plurality of nozzle applicators. For example, the plurality of nozzle applicators can be positioned along an outline of a shape of diamond and the plurality of bristles can be positioned within the interior and surrounding the exterior of the plurality of nozzle applicators. This shape can allow the hair care product to be spread more easily by the plurality of bristles surrounding the plurality of nozzle applicators.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense. The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” something can refer to one or more such things. For example, “a number of users” can refer to one or more users. Additionally, the designator “N”, as used herein, particularly with respect to reference numerals in the drawings, indicates that a number of the particular feature so designated can be included with a number of embodiments of the present disclosure.

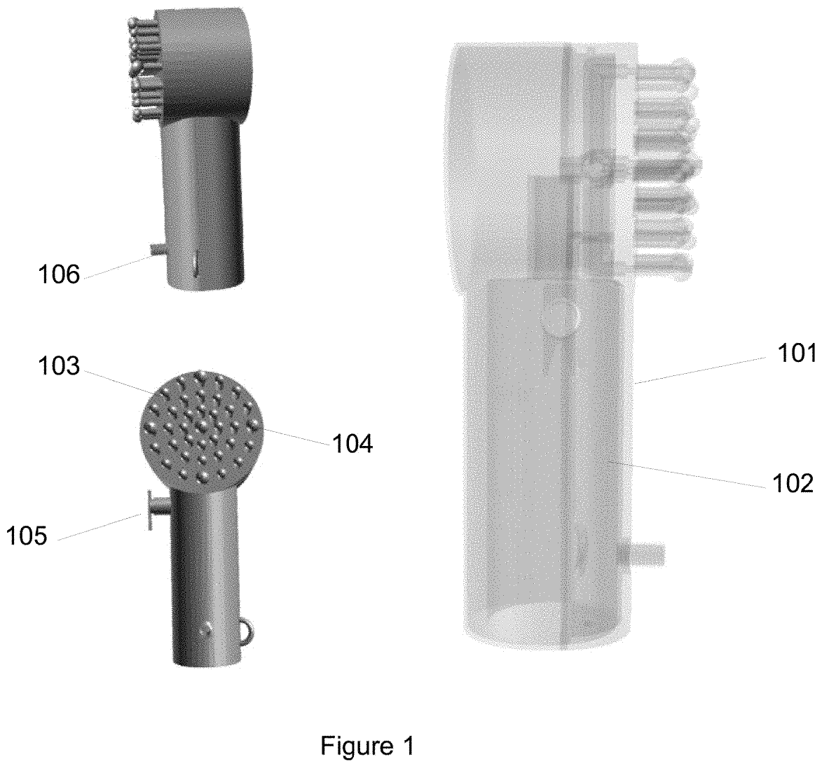

FIG. 1 is an example of a Style Sealer Applicator 100 in the form of a brush according to one or more embodiments of the present disclosure. FIG. 1 illustrates the handle 101 with an integrated reservoir 102 that is coupled to the nozzle applicators 103 which are integrated with the bristles 104. The reservoir 102 is pressurized by a push button actuator 105 which pressurizes the reservoir to dispense hair care products out of the nozzle applicators 103, The reservoir 102 can be conveniently refilled with hair care product through the input port 106.

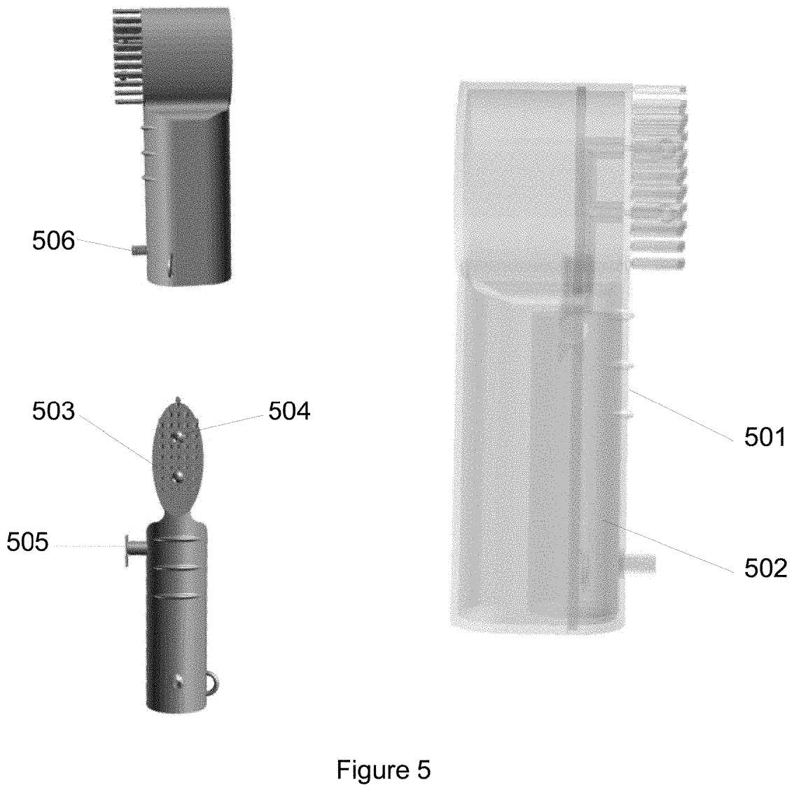

In various examples the Style Sealers Applicator 100 can be in the form of a hair brush which is designed to detangle hair by having thicker and denser bristles that are spaced farther apart and nozzle applicators that deliver styling/grooming-′moisturizing hair products aligned in a cross shape. Style Sealer Applicator 100 is designed specifically to detangle thicker coarser hair that's usually groomed in wefts, and is found in textured hair. The plurality of bristles 104 for Style Sealers Applicator 100 are spaced wider compared to other embodiments such as Style Sealers Applicator 500 as illustrated in FIG. 5, which allows the user to detangle their hair with less discomfort, and spaces out the hair more to help deliver the hair products directly to the scalp. Style Sealers 100 provides uniform coverage of the hair care product and aids in reducing itchy/dry scalp, dandruff and helps moisturize the hair and scalp.

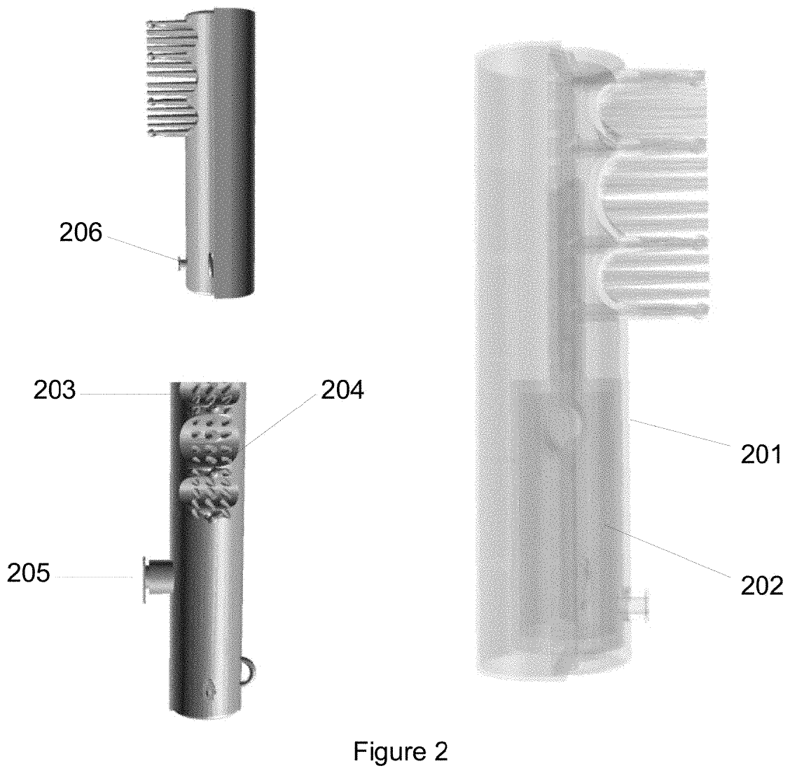

In some examples, the nozzle applicators 103 and the bristles 104 are arranged in a cross like pattern which is designed specifically to detangle thicker coarser hair that's usually groomed in wefts. The bristles 104 are thicker, stiffer and spaced wider apart then other embodiments of the invention and the wider spacing allows the textured hair user to detangle their hair with less discomfort. FIG. 2 is an example of a Style Sealer Applicator in the form of a comb according to one or more embodiments of the present disclosure. FIG. 2 illustrates the handle 201 with an integrated reservoir 202 that is coupled to the nozzle applicators 203 which are integrated with the bristles 204. The reservoir 202 is pressurized by a push button actuator 205 which pressurizes the reservoir to dispense hair care products out of the nozzle applicators 203. The reservoir 202 can be conveniently refilled with hair care product through the input port 206.

In various examples the Style Sealers Applicator 200 can be in the form of a comb that has bristles 204 patterned with the nozzle applicators 203 that deliver the styling/grooming/moisturizing hair products. A user could use Style Sealer Applicator 200 after the hair has been washed and dried. The Style Sealer Applicator 200 can be used to straighten sections of hair at a time which are commonly referred to as a “wefts.” These wefts of textured hair are straitened with the comb after being detangled with the brush. The hair care product applied by Style Sealer Applicator 200 would condition and moisturize the hair to prevent breakage and assist in the straightening process. The nozzle applicators 203 of Style Sealers Applicator 200 can be shorter than the bristles 204 by between 0.2 and 0.5 mm to help apply the hair care product to the hair.

In some examples, the nozzle applicators 203 can be arranged in a single row down the middle of the plurality of bristles 204 to help with the even distribution of the hair care product during combing. The nozzle applicators 203 for this embodiment would be shorter than the bristles 204, this offset would allow the product to be applied to the hair more gently as it was deposited on the hair during the combing process.

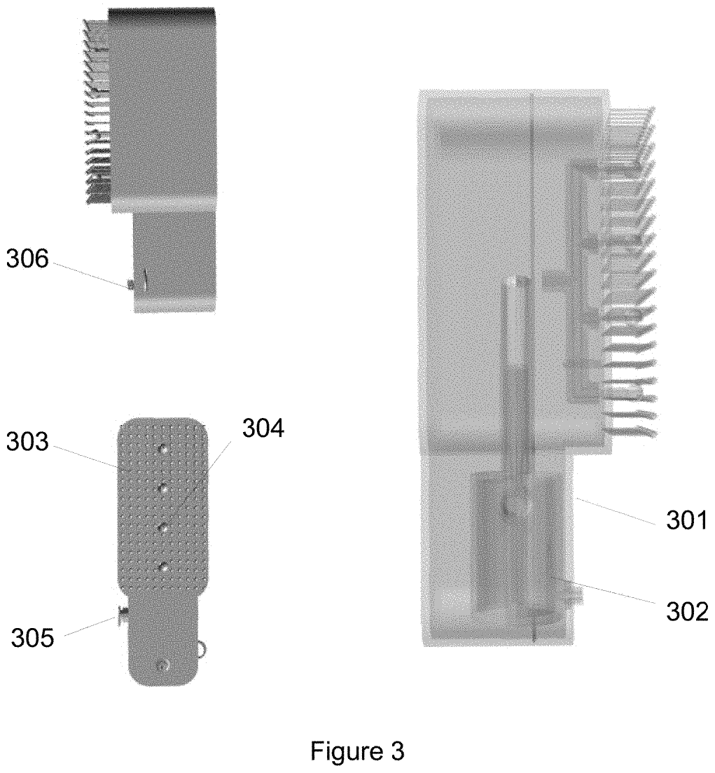

FIG. 3 is an example of a. Style Sealer Applicator in the form of a wave brush according to one or more embodiments of the present disclosure. FIG. 3 illustrates the handle 301 with an integrated reservoir 302 that is coupled to the nozzle applicators 303 which are integrated with the bristles 304 The reservoir 302 is pressurized by a push button actuator 305 which pressurizes the reservoir to dispense hair care products out of the nozzle applicators 303. The reservoir 302 can be conveniently refilled with hair care product through the input port 306.

In various examples the Style Sealers Applicator 300 can be in the form of a wave brush that has bristles patterned with the nozzle applicators 303 that deliver styling/grooming/moisturizing hair products. Style Sealers Applicator 300 can be used by men with short hair to create a “wave” pattern in the hair. The Style Sealers Applicator 300 can be used on the top layers of hair to style with the grain of the hair to create the wave pattern. The nozzle applicators 303 of Style Sealers Applicator 300 are aligned in a single row along the centerline of the brush head to help form the wave pattern in the hair. The hair care products that are applied by Style Sealer Applicator 300 are focused primarily on the hair. One example of a hair care product being applied by Style Sealers Applicator 300 is shave butter to moisturize the hair. The bristles 304 and the nozzle applicators 303 of Style Sealers Applicator 300 are shorter and thinner than other forms of the device such as Style Sealer Applicator 100 as illustrated in FIG. 1 to better suit the shorter textured hair.

In some examples the nozzle applicators 303 are oriented in a single row located along the centerline of the plurality of bristles 304. The nozzle applicators 303 and the bristles 304 are shorter and thinner than other embodiments of the invention to better suit the application of creating the wave pattern in shorter textured hair.

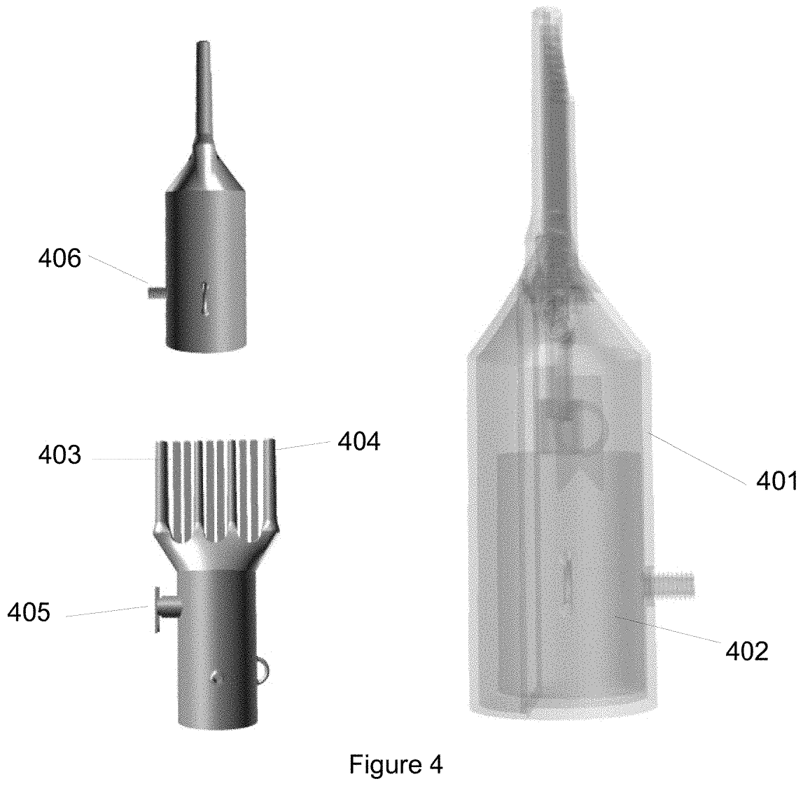

FIG. 4 is an example of a Style Sealer Applicator in the form of a pick according to one or more embodiments of the present disclosure. FIG. 4 illustrates the handle 401 with an integrated reservoir 402 that is coupled to the nozzle applicators 403 which are integrated with the bristles 404 The reservoir 402 is pressurized by a push button actuator 405 which pressurizes the reservoir to dispense hair care products out of the nozzle applicators 403. The reservoir 402 can be conveniently refilled with hair care product through the input port 406.

In various examples the Style Sealers Applicator 400 can be in the form of a hair pick which has nozzle applicators 503 inside some of the teeth to fluff out thick, coarse, or matted textured hair. Style Sealers Applicator 400 could be used for a beard or an Afro of a textured hair user. Style Sealers Applicator 400 can be used during or after washing to apply a hair care product to help moisturize or oil the hair. Style Sealers Applicator 400 can be used as a styling tool itself or as a preparation step for another hair styling tool in the process of styling the hair. The bristles 404 of Style Sealers Applicator 400 are the longest and stiffest of all the embodiments being upwards of 10 inches long and requiring several pounds of force to flex. The bristles 404 are all aligned in a single row with some of the bristles being replaced by nozzle applicators 403.

FIG. 5 is an example of a Style Sealer Applicator in the form of an edge brush according to one or more embodiments of the present disclosure. FIG. 5 illustrates the handle 501 with an integrated reservoir 502 that is coupled to the nozzle applicators 503 which are integrated with the bristles 504 The reservoir 502 is pressurized by a push button actuator 505 which pressurizes the reservoir to dispense hair care products out of the nozzle applicators 503. The reservoir 402 can be conveniently refilled with hair care product through the input port 506.

In some examples, the Style Sealers Applicator 500 can be in the form of an edge brush which has closer spaced and thinner bristles with nozzle applicators 503 that create a tighter pattern to deliver styling/grooming/moisturizing hair products in a concentrated area. For Style Sealers Applicator 500 the nozzle applicators 503 are aligned vertically along the center line of the pattern, which aids in the detailed task of maintaining, styling and grooming textured hair edges. The nozzle applicators are able to deliver hair products while styling the hair edges in a uniform fashion which greatly improves the usability. Previous systems lack the ease of use of applying the hair care product with one hand in a uniform manner to adequately style the hair edges.

The hair care product that could be used with Style Sealer Applicator 500 is any type of edge control gel. This hair care product is designed to harden once dried to lock the hair in place for a certain styling look. Previous systems suffer from clogging of the nozzle applicators with the hair care products and losing bristles due to the design defects. Style Sealers Applicator 500 is made with the bristles as one piece with the brush head to eliminate the loss of bristles 504 over time. This design also makes it possible for easier and more thorough cleaning of the bristles that prevents clogging of the bristles over time.

As used herein a bristle is a semi rigid cylindrical plastic piece that is between 0.25-10 in long. In some embodiments a small spherical shape is created out of one end of the cylinder to round out the edges and make the bristles gentler on the skin and hair when brushed. Different embodiments of the invention require different levels of stiffness of the bristles to accommodate the different applications. The stiffness is the amount of force to cause a member to bend. The Style Sealers Applicator 100 and 400 have the most stiff bristles requiring several pounds of force to bend the bristles. The Style Sealers Applicator 500 has the least stiff bristles requiring less than half a pound of force. With the Style Sealers Applicators 200 and 300 have a stiffness somewhere in between. To achieve the required stiffness for the different embodiments the diameter of the cylinder and the material it is made out of can be modified to yield the appropriate stiffness among other factors.

As used herein a nozzle applicator is a cylindrical tube that allows hair care product to be transferred from the manifold to the hair. The nozzle applicators are inter spaced with the bristles to allow the dispensing of hair care product while the hair is being styled. The nozzle applicators are oriented in specific patterns depending on the embodiment and therefore are usually stiffer then the accompanying bristles to maintain the pattern while in use. The inner diameter of the tube can vary with the different embodiments to accommodate the different viscosity of the hair care products to achieve an appropriate flow rate when the reservoir is activated. For higher viscosity hair care products such as edge control gel the inner diameter of the tube needs to be bigger to allow an appropriate amount of product to be dispensed and not require the user to exert an increased force to dispense the product from the device. For lower viscosity hair care products such as hair oil the inner diameter of the tube needs to be smaller to avoid excess discharge from the device when the reservoir is activated.

As used herein a manifold is a system of tubes or pipes that evenly distribute the hair care product from the single tube coming from the reservoir to all the individual nozzle applicators. The manifold is necessary so that the hair care product is evenly distributed out of the nozzle applicators. Without a proper manifold there will be a gradient where the hair care product is discharged in a greater volume out of the nozzle applicators that are closer to the reservoir and decrease volume the farther away the nozzle applicator is from the reservoir. For one skilled in the art the manifold can be designed to receive more than one tube coming from the reservoir and distribute hair care product to any number of nozzle applicators.

As used herein an input port is an opening in the reservoir that is accessible from the outside of the device to allow easy access to refill the reservoir with hair care product. The input port can have a method for sealing the reservoir when not being filled such as a threaded cap, or a one way valve.

As used herein a reservoir is a tank that can store a liquid or gel substance and has an input port, an exit port. The most common embodiment of the invention has a cylindrical tank with an actuation device that pressurizes the contents to push the hair care product out of the exit port when the input port is sealed. The exit port is coupled to the manifold and the manifold is coupled to the nozzle applicators to transfer the hair care product from the reservoir all the way through the nozzle applicators with the pressure from the actuation device. For one skilled in the art the reservoir could be any form of a bag/pouch/tank/vessel/apparatus that is used to store hair care product.

As used herein an actuation device is a method to push or pull a substance out of the reservoir. The most common embodiment of the invention is a spring loaded push button that pressurizes the contents in the reservoir to force the substance out of the exit port when the input port is sealed. This embodiment has the added utility of only requiring one finger to actuate and makes the process of applying the hair care product while styling easier on the user. The user can have a free hand to assist in the styling and can maintain a firm grip on the tool and apply the hair care product more consistently. An alternative implementation is the actuation device causes a suction action that pulls the substance out of the exit port.

As used herein a brush head is the body of the tool that houses the manifold and is coupled to the handle and the plurality of bristles and nozzle applicators. The shape of the brush head can vary depending on the embodiment but is most commonly a variation of the oval. Some embodiments such as Style Sealers 100 as referenced in FIG. 1 require a larger oval while Style Sealers 300 as referenced in FIG. 3 requires a smaller oval for the brush head based on the requirements of the tool. Embodiments such as Style Sealer Applicator 400 as referenced in FIG. 4 have the brush head the shape of a rectangle. The manifold is contained within the brush head and connects the reservoir in the handle to the nozzle applicators coupled to the brush head.

As used herein a hair care product is any kind of substance that is applied to help style, moisturize, groom, or oil the hair and scalp. Different styling techniques and user preferences require a wide variety of hair care products which the present invention is able to accommodate with the different embodiments. Some embodiments such as Style Sealers Applicator 400 as referenced in FIG. 4 typically use oil or other less viscus substances in styling while Style Sealers Applicator 500 as referenced in FIG. 5 requires a type of edge gel which is a more viscus substance that hardens when dries.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above elements and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A substance applicator device, comprising:
a handle with a hollow core;
a reservoir positioned within the hollow core of the handle;
an input port coupled to the reservoir to fill a hair care product into the reservoir;
an actuation device that is coupled to the handle and coupled to the reservoir to pressurize the reservoir;
a plurality of nozzle applicators as an outlet for dispensing the hair care product from the device; and
a plurality of bristles.

2. The substance applicator device of claim 1, wherein the plurality of bristles and the plurality nozzle applicators are oriented to evenly distribute a hair care product onto a surface.

3. The substance applicator device of claim 2, wherein the actuation device is a spring loaded push button that can be depressed to dispense the hair care product through the plurality of nozzle applicators.

4. The substance applicator device of claim 1, wherein the plurality of bristles and the plurality of nozzle applicators are inter-spaced on a brush head that is coupled to the handle.

5. The substance applicator device of claim 4, wherein the plurality of nozzle applicators are offset from the length of the plurality of bristles such that the plurality of bristles are longer than the plurality of nozzle applicators.

6. The substance applicator device of claim 5, wherein the reservoir is coupled to the plurality of nozzle applicators by a piece of tubing coupled to a distributor manifold capable of transporting the hair care product from the reservoir to each aperture of the plurality of nozzle applicators.

7. A substance applicator device, comprising:
a handle with a hollow core;
a reservoir positioned within the hollowed out core of the handle;
an input port coupled to a surface of the handle and coupled to the reservoir to insert a hair care product into the reservoir;
an actuation device that is coupled to the handle and coupled to the reservoir to pressurize the reservoir;
a plurality of nozzle applicators as an outlet for dispensing the hair care product from the device; and
a plurality of bristles oriented in a configuration with the plurality of nozzle applicators to create a pattern.

8. The substance applicator device of claim 7, wherein the actuation device is a spring loaded push button that can be depressed to increase a pressure within the reservoir to dispense the hair care product from the plurality of nozzle applicators.

9. The substance applicator device of claim 8, wherein the plurality of nozzle applicators are offset from the length of the plurality of bristles such that the plurality of bristles would be longer than the plurality of nozzle applicators.

10. The substance applicator device of claim 9, wherein the plurality of bristles and the plurality of nozzle applicators are inter-spaced on a brush head that is coupled to the handle.

11. The substance applicator device of claim 10, wherein the pattern of bristles and nozzle applicators is oriented in an oval with a long axis running parallel to the length of the handle.

12. The substance applicator device of claim 7, wherein the plurality of bristles are semi rigid and a same length as the handle.

13. The substance applicator device of claim 12, wherein the pattern of bristles and nozzle applicators are oriented with a single row running perpendicular to the length of the handle.

14. The substance applicator device of claim 13, wherein the plurality of nozzle applicators are positioned in a center of the single row and on the two ends with the plurality of bristles inter spaced in between.

15. A substance applicator device, comprising:
a handle with a hollow core;
a reservoir positioned within the hollowed out core of the handle;
an input port coupled to a surface of the handle and coupled to the reservoir to insert a hair care product into the reservoir;
a push button actuation device that can be depressed to dispense hair care product from the reservoir;
a plurality of nozzle applicators as an outlet for dispensing the hair care product from the device; and
a plurality of bristles oriented in a configuration with the plurality of nozzle applicators to dispense the hair care product from the device.

16. The substance applicator device of claim 15, wherein the plurality of bristles are made out of a material that has a stiffness to accommodate styling of hair.

17. The substance applicator device of claim 16, wherein the plurality of bristles is spaced in linearly in a single row running perpendicular to the length of the handle.

18. The substance applicator device of claim 15, wherein use plurality of nozzle applicators are spaced evenly.

19. The substance applicator device of claim 18, wherein the pattern of bristles and nozzle applicators is oriented in an oval with the long axis running parallel to the length of the handle.

20. The substance applicator device of claim 15, wherein the plurality of nozzle applicators are spaced in a diamond configuration with the plurality of bristles inter spaced in between the plurality of nozzle applicators.
